(19) United States
(12) Patent Application Publication
(10) Pub. No.: US 2014/0160967 A1
(43) Pub. Date: Jun. 12, 2014

(54) Interference Control in Time Division Duplex Communication

(71) Applicants: Chunyan Gao, Beijing (CN); Erlin Zeng, Beijing (CN); Haiming Wang, Beijing (CN); Jing Han, Beijing (CN); Wei Hong, Beijing (CN)

(72) Inventors: Chunyan Gao, Beijing (CN); Erlin Zeng, Beijing (CN); Haiming Wang, Beijing (CN); Jing Han, Beijing (CN); Wei Hong, Beijing (CN)

(73) Assignee: BROADCOM CORPORATION, Irvine, CA (US)

(21) Appl. No.: 14/124,064

(22) PCT Filed: Jun. 9, 2011
(86) PCT No.: PCT/CN2011/075502

§ 371 Date: Feb. 28, 2014

(51) Int. Cl. H04L 5/00; H04L 5/14; H04W 24/08

(52) U.S. Cl. CPC H04L 5/0073; H04W 24/08; H04L 5/14
USPC 370/252

(57) ABSTRACT

There are provided measures for interference control in time division duplex communication. Such measures may exemplarily comprise setting up a predefined uplink-downlink configuration of a frame structure for time division duplex communication, said frame structure comprising a predefined number of downlink subframes, deriving measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and performing an interference measurement for the downlink subframes of at least one of the measurement groups.

### FIELD OF THE INVENTION

The present invention relates to interference control in time division duplex communication. More specifically, the present invention relates to measures (including methods, apparatuses and computer program products) for interference control in time division duplex communication.

### BACKGROUND

In the field of communication systems, including wireless and/or cellular communication systems, various techniques are known for concurrently utilizing a physical channel for both transmitting and receiving operations, i.e. for communication in both transmitting and receiving directions from the viewpoint of a system entity in questions. One of these known channel utilization techniques is Time Division Duplex (TDD) in which transmitting ands receiving channels utilize a common frequency spectrum while being temporally separated from each other.

The TDD technique is effective by offering flexible deployments without requiring a pair of spectrum resources, which is especially beneficial in wireless communication systems having limited spectrum resources. Further, the TDD technique is effective by allowing an asymmetric uplink-downlink (UL-DL) resource allocation in that a different number of resources (e.g. blocks, frames, subframes or the like) are allocated for uplink and downlink communications.

In view of these features, TDD is currently utilized in various communication systems, including wireless and/or cellular communication systems, e.g. LTE and LTE-A.

In connection with an asymmetric UL-DL resource allocation in TDD when applied in a cellular communication system, there arises a problem of interference between uplink and downlink communications in neighboring cells. Such UL-DL interference may include both base station-to-base station (e.g. eNB-to-eNB) interferences and terminal-to-terminal (e.g. UE-to-UE) interference, which needs to be considered in terms of communication performance and efficiency. The UL-DL interference in a TDD network is typically handled by statically provisioning a guard period and adopting the same frame timing and UL-DL configuration (i.e. configuration of allocation of resources to uplink and downlink communications) practically in the entire communication system.

However, adopting the same UL-DL configuration is typically inadequate in cellular communication systems. This is because different traffic situations in different (including neighboring) cells could most appropriately be handled by different UL-DL configurations, i.e. a differently distributed allocation of the available resources to UL and DL communications).

In view of different UL-DL configuration, UL-DL interference is a general problem in neighboring cells of cellular communication system utilizing TDD. In particular, it may be a special problem in local area (LA) networks utilizing TDD. Namely, since in LA networks the typical cell size is small in comparison with a typical (macro) cell and the number of terminals connected to each base station (e.g. eNB or AP) in the network is not large, there is an increased possibility that the traffic situation in different LA cells may only be adequately handled by different UL-DL configurations.

Due to different TDD UL-DL configurations in neighboring cells and the resulting UL-DL interference in some subframes (when considering subframes of a frame structure as a basic resource unit), the SINR in these subframes can be much lower than that the normal SINR of subframes without DL-UL interference. By considering such difference in scheduling, resource efficiency can be improved and interference can be reduced.

However, no measurement and reporting procedures are currently known or specified, which would be required to enable such interference reduction and resource efficiency improvement. In this connection, there are currently studied potential enhancements for interference management and traffic adaptation in the context of LTE/LTE-A standardization, such as interference mitigation schemes for deployment scenarios comprising same or different UL-DL configurations and UL-DL re-configuration schemes depending upon traffic conditions.

In view thereof, there exist problems in addressing UL-DL interference in the application of TDD in cellular communication systems, especially when adopting different TDD UL-DL configurations in different (including neighboring) cells.

Thus, there is a need to further improve interference control in time division duplex communication.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising setting up a predefined uplink-downlink configuration of a frame structure for time division duplex communication, said frame structure comprising a predefined number of downlink subframes, deriving measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and performing an interference measurement for the downlink subframes of at least one of the measurement groups.

According to further developments or modifications thereof, the method may for example further comprise receiving a measurement configuration defining a set of all downlink subframes of the frame structure or at least three subsets of the downlink subframes of the frame structure, wherein the at least three subsets of the downlink subframes, which are defined by the received measurement configuration, are derived as the measurement groups.

According to further developments or modifications thereof, the method may for example further receiving a measurement configuration defining a set of all downlink subframes of the frame structure or at least two subsets of the downlink subframes of the frame structure, said deriving comprising dividing at least one of the set of all downlink subframes and the at least two subsets of the downlink subframes, which are defined by the received measurement configuration, wherein the at least three subsets of the downlink subframes, which result from said dividing of the at least two subsets of the downlink subframes of the received measurement configuration, or the at least two subsets of the downlink subframes, which result from said dividing of the set of all downlink subframes of the received measurement configuration, are derived as the measurement groups.

According to an exemplary aspect of the present invention, there is provided a method comprising configuring a predefined uplink-downlink configuration of a frame structure for time division duplex communication, said frame structure comprising a predefined number of downlink subframes, configuring a measurement configuration defining a set of all downlink subframes of the frame structure or at least two subsets of the downlink subframes of the frame structure, and transmitting the predefined uplink-downlink configuration and the measurement configuration to a terminal or user equipment of a cellular communication system.

According to further developments or modifications thereof, the measurement configuration may for example be configured to define a set of all downlink subframes of the frame structure or at least three subsets of the downlink subframes of the frame structure, or to define a set of all downlink subframes of the frame structure or at least two subsets of the downlink subframes of the frame structure.

According to an exemplary aspect of the present invention, there is provided an apparatus comprising an interface configured for communication with at least another apparatus on the basis of a predefined uplink-downlink configuration of a frame structure for time division duplex communication, and a processor configured to set up the predefined uplink-downlink configuration of the frame structure for time division duplex communication, said frame structure comprising a predefined number of downlink subframes, derive measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and perform an interference measurement for the downlink subframes of at least one of the measurement groups.

According to further developments or modifications thereof, the processor may for example be configured to receive a measurement configuration defining a set of all downlink subframes of the frame structure or at least three subsets of the downlink subframes of the frame structure, and to derive, as the measurement groups, the at least three subsets of the downlink subframes, which are defined by the received measurement configuration.

According to further developments or modifications thereof, the processor may for example be configured to receive a measurement configuration defining a set of all downlink subframes of the frame structure or at least two subsets of the downlink subframes of the frame structure, and to divide at least one of the set of all downlink subframes and the at least two subsets of the downlink subframes, which are defined by the received measurement configuration, and to derive, as the measurement groups, the at least three subsets of the downlink subframes, which result from said dividing of the at least two subsets of the downlink subframes of the received measurement configuration, or the at least two subsets of the downlink subframes, which result from said dividing of the set of all downlink subframes of the received measurement configuration.

According to an exemplary aspect of the present invention, there is provided an apparatus comprising an interface configured for communication with at least another apparatus on the basis of a predefined uplink-downlink configuration of a frame structure for time division duplex communication, and a processor configured to configure the predefined uplink-downlink configuration of the frame structure for time division duplex communication, said frame structure comprising a predefined number of downlink subframes, configure a measurement configuration defining a set of all downlink subframes of the frame structure or at least two subsets of the downlink subframes of the frame structure, and transmit, via the interface, the predefined uplink-downlink configuration and the measurement configuration to a terminal or user equipment of a cellular communication system.

According to further developments or modifications thereof, the processor may for example be configured to configure the measurement configuration to define a set of all downlink subframes of the frame structure or at least three subsets of the downlink subframes of the frame structure, or to define a set of all downlink subframes of the frame structure or at least two subsets of the downlink subframes of the frame structure.

According to an exemplary aspect of the present invention, there is provided a computer program product comprising computer-executable components which, when the program is run on a computer (e.g. of any one of the aforementioned apparatus-related aspects), are configured to execute the method according to any one of the aforementioned method-related aspects.

By way of exemplary embodiments of the present invention, there is provided interference control in time division duplex communication (in/for cellular communication systems). More specifically, by way of exemplary embodiments of the present invention, there are provided measures and mechanisms for interference control in time division duplex communication (in/for cellular communication systems).

Thus, improvement is achieved by methods, devices and computer program products enabling interference control in time division duplex communication (in/for cellular communication systems).

### BRIEF DESCRIPTION OF DRAWINGS

For a more complete understanding of exemplary embodiments of the present invention, reference is now made to the following description taken in connection with the accompanying drawings in which:

FIG. 1 shows a schematic diagram of a first example of an arrangement of cell-specific TDD UL-DL configurations, for which exemplary embodiments of the present invention are applicable,

FIG. 2 shows a schematic diagram of a second example of an arrangement of cell-specific TDD UL-DL configurations, for which exemplary embodiments of the present invention are applicable,

FIG. 3 shows a flowchart of a method, which may be operable at a terminal, according to exemplary embodiments of the present invention,

FIG. 4 shows a flowchart of a method, which may be operable at a network entity, according to exemplary embodiments of the present invention,

FIG. 5 shows a schematic diagram of a mapping procedure according to exemplary embodiments of the present invention,

FIG. 6 shows a signaling diagram illustrating a procedure according to exemplary embodiments of the present invention, and

FIG. 7 shows a block diagram illustrating exemplary apparatuses according to exemplary embodiments of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following exemplary description mainly refers to specifications being used as non-limiting examples for certain exemplary network configurations and deployments. In particular, for the applicability of thus described exemplary aspects and embodiments, LTE- (including LTE-Advanced-) related cellular communication networks are used as non-limiting examples. As such, the description of exemplary aspects and embodiments given herein specifically refers to terminology which is directly related thereto. Such terminology is only used in the context of the presented non-limiting examples, and does naturally not limit the invention in any way. Rather, any other communication systems, network configurations or system deployments, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided mechanisms, measures and means for interference control in time division duplex communication (in/for cellular communication systems).

While exemplary embodiments of the present invention are generally applicable to any cellular communication system utilizing TDD, exemplary embodiments of the present invention are specifically beneficial for TDD systems in a local area scenario. For example, exemplary embodiments of the present invention are applicable in TDD LA networks which are utilized in LTE/LTE-A-based communication systems. Accordingly, exemplary embodiments of the present invention are considered to be specifically applicable for example for LTE Release 11 onwards, including e.g. layered heterogeneous network deployments, deployments involving different carriers deployed in the same frequency band (such as in the context of carrier aggregation), and the like.

In the following, exemplary embodiments of the present invention are described with reference to methods, procedures and functions, as well as with reference to structural arrangements and configurations.

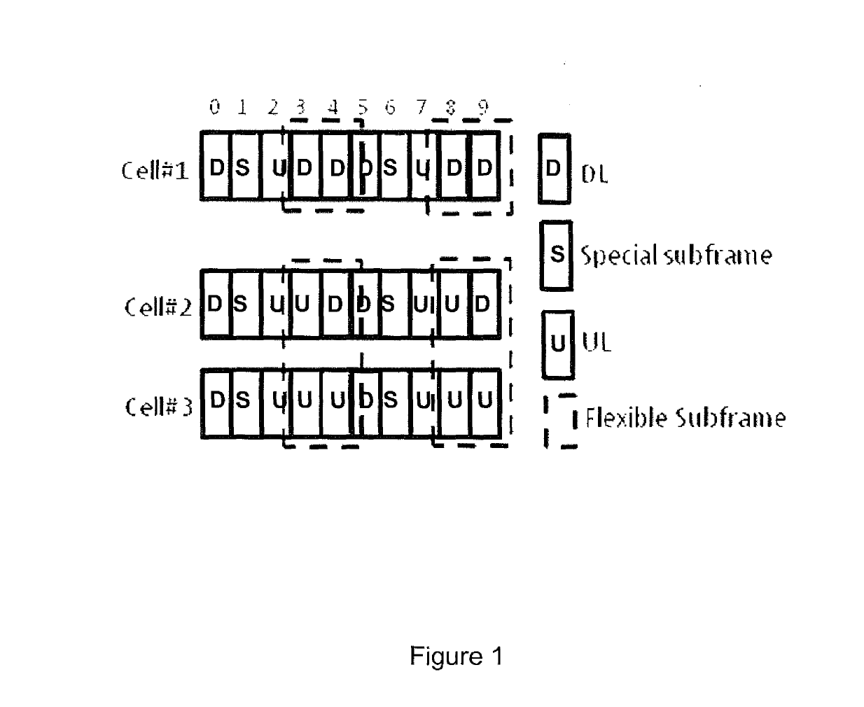

In the context of LTE TDD systems, seven different semi-statically configured UL-DL configurations are specified for realizing an asymmetric resource allocation. The resource allocations, which may be realized by these specified UL-DL configurations, provide between 40% and 90% of DL subframes, i.e. DL capacity. In the following table, these specified UL-DL configurations are shown, wherein D indicates a DL subframe, U indicates an UL subframe, and S indicates a special subframe (which denotation is also used in FIGS. 1, 2 and 6 below).

As evident from the table, even when assuming frame synchronization, there is no switch-point synchronization between all of the specified UL-DL configurations (i.e. special subframes are present in both half-frames in configurations 0, 1, 2 and 6, while special subframes are present in only one half-frame in configurations 3 to 5).

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

As mentioned above, DL-UL interference is one obstacle to deploy flexible TDD cellular systems, in particular TDD LA cellular systems. In case each cell of such system chooses one TDD UL-DL configuration from the seven specified TDD UL-DL configurations outlined above, there is no UL-DL interference problem for subframes 0, 1, 2 and 5, since these subframes have a fixed link direction in any one of the TDD UL-DL configurations. For other subframes, their link direction can change with the TDD UL-DL configuration, and there can be UL-DL interference depending on the TDD UL-DL configuration adopted in neighboring cells.

In the present specification, those subframes (like subframes 0, 1, 2 and 5) having a fixed link direction are referred to as fixed subframe, while those subframes having a variable link direction are referred to as flexible subframe.

While subframes 0, 1, 2 and 5 are always fixed subframes in any arrangement, the fixed and flexible subframes can change depending on which ones of the TDD UL-DL configurations are (allowed to be) adopted by neighboring cells. For example, if a network only supports TDD UL-DL configuration 1 and 2, then subframes 0, 1, 2, 4, 5, 6, 7, 9 are all fixed subframes, while subframes 3 and 8 are flexible subframes which are set as UL in configuration 1 and as DL in configuration 2.

Accordingly, UL-DL interference may be present for flexible subframes. The UL-DL interference in flexible subframes will degrade the SINR significantly. In this regard, it is to be noted that the difference in SINR may exist not only when comparing flexible subframes and fixed subframes, but it may also exist when comparing different flexible subframes with each other.

FIG. 1 shows a schematic diagram of a first example of an arrangement of cell-specific TDD UL-DL configurations, for which exemplary embodiments of the present invention are applicable.

As shown in FIG. 1, it is exemplarily assumed that TDD UL-DL configurations 0, 1 and 2 are used, i.e. different UL-DL configurations are used in neighboring cells. In the example of FIG. 1, cell#1 adopts TDD UL-DL configuration 2, cell#2 adopts TDD UL-DL configuration 1, and cell#3 adopts TDD UL-DL configuration 0. Accordingly, subframes 3, 4, 8 and 9 are flexible subframes in the exemplary arrangement of different TDD UL-DL configurations, and there can be more interference in DL subframes 3 and 8 while there can be less interference in DL subframes 4 and 9 when conceived from the point of view of cell#1.

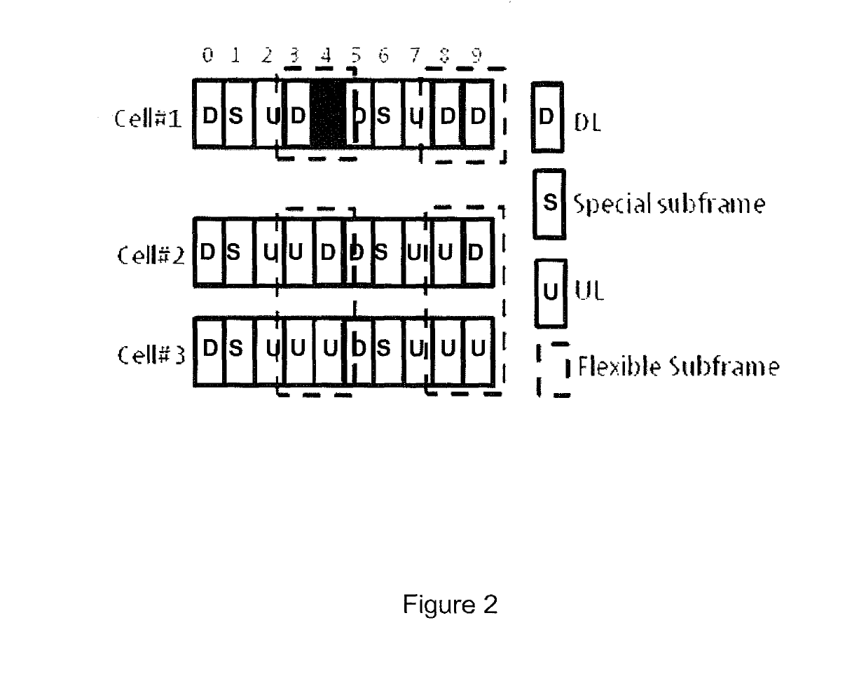

FIG. 2 shows a schematic diagram of a second example of an arrangement of cell-specific TDD UL-DL configurations, for which exemplary embodiments of the present invention are applicable.

As shown in FIG. 2, while the same arrangement of different TDD UL-DL configurations as in FIG. 1 is assumed, it is exemplarily assumed that DL subframe 4 of cell#1 is muted (which is indicated by a black box). The case of muting is considered here, since muting some subframe can be seen as an approach for reducing UL-DL interference reduction. The muting can be caused by less traffic or terminals in the cell, e.g. cell#1, or definitely used, i.e. Instructed, for interference reduction. In case of the muting of subframe 4 in cell#1 in the example of FIG. 2, the interference in the two flexible subframes 4 and 9 in cell#2 can be largely different. For subframe 4, since there is no data transmission in neighboring cell#1, the Interference can be less than in subframe 9.

From the above, it is clear that SINR in DL subframes of one cell, i.e. the interference level, can change from subframe to subframe. For data transmission in flexible subframes, link adaptation and/or HARQ can help to adapt to the interference level. Such approach is practicable only when the interference level between specific subframes is known to the network entity responsible for such measures (e.g. eNB or RNC).

However, the difference in interference level between flexible subframes is not known by a base station (e.g. eNB) without any inter-eNB coordination or terminal reports. For being enabled to properly address the interference situation in the flexible subframes, the base station needs to have a detailed picture of differences of SINR or interference level with a sufficient resolution in terms of involved subframes.

Moreover, inter-eNB information sharing on the TDD UL-DL configuration may make an eNB aware of the existence of potential SINR or interference differences (e.g. that there is more interference in subframe 4 when compared with subframe 0, and there is less interference in subframe 4 when compared with subframe 3), but the exact value of the SINR or interference difference may not be known until a respective terminal measures and reports for these subframes separately.

In view thereof, conventional approaches are insufficient, which may only provide for a unified measurement and reporting involving all DL subframes. This is because a unified report for all the DL subframes is less useful for link adaptation and/or HARQ, and it may reduce resource efficiency of fixed subframe or cause high interference in flexible subframes.

According to exemplary embodiments of the present invention, there are provided improvement in interference control in time division duplex communication in view of the above.

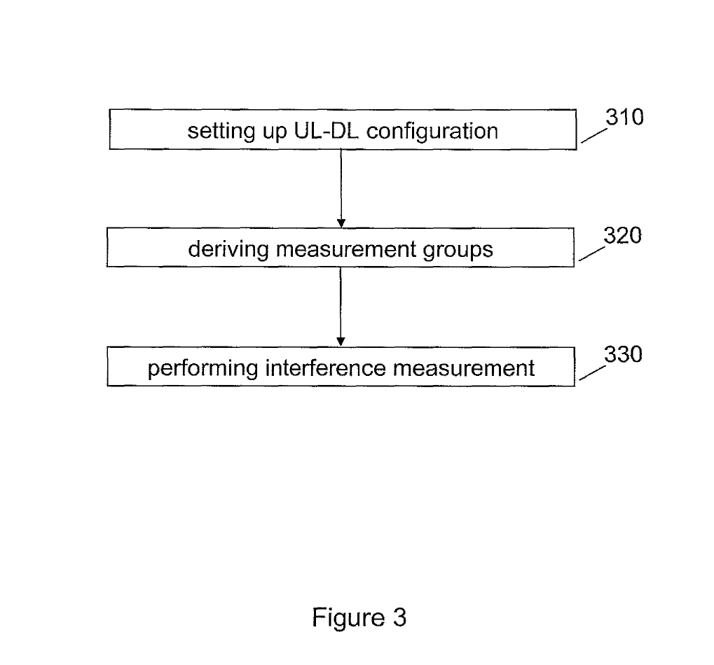

FIG. 3 shows a flowchart of a method according to exemplary embodiments of the present invention. The method of FIG. 3 is operable at or by a terminal or user equipment of a cellular communication system, e.g. by an UE of a LTE/LTE-A system utilizing TDD or the like.

As shown in FIG. 3, a method according to exemplary embodiments of the present invention may comprise an operation of setting up (310) a predefined UL-DL configuration of a frame structure for TDD communication, said frame structure comprising a predefined number of DL subframes, an operation of deriving (320) measurement groups from the frame structure according to a measurement configuration, said measurement configuration defining a set of all DL subframes of the frame structure or at least two subsets of the DL subframes of the frame structure (which may but need not be complementary), each of said measurement groups comprising a set of subframes out of the DL subframes of the frame structure, and an operation of performing (330) an interference measurement for the DL subframes of at least one of the measurement groups.

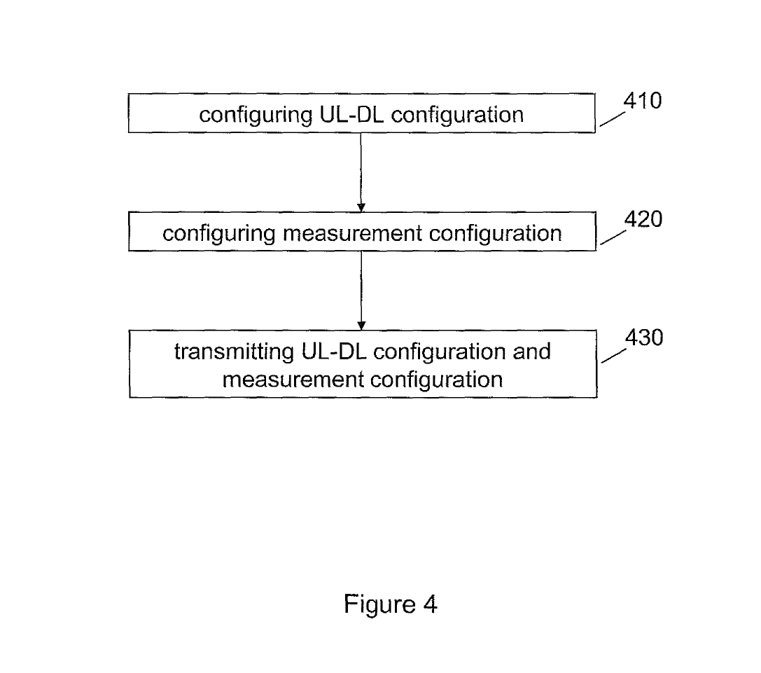

FIG. 4 shows a flowchart of a method according to exemplary embodiments of the present invention. The method of FIG. 4 is operable at or by an access node or base station of a cellular communication system, e.g. by an eNB of a LTE/LTE-A system utilizing TDD or the like.

As shown in FIG. 4, a method according to exemplary embodiments of the present invention may comprise an operation of configuring (410) a predefined UL-DL configuration of a frame structure for TDD communication, said frame structure comprising a predefined number of downlink subframes, configuring (420) a measurement configuration defining a set of all DL subframes of the frame structure or at least two subsets of the DL subframes of the frame structure (which may but need not be complementary), and transmitting (430) the predefined UL-DL configuration and the measurement configuration to a terminal or user equipment of a cellular communication system.

According to exemplary embodiments of the present invention, communication is based on the TDD technique, and a predefined UL-DL configuration is one of the seven specified TDD UL-DL configurations as outlined above.

According to exemplary embodiments of the present invention, a base station may configure the predefined UL-DL configuration to be used for communication in its cell, and inform, i.e. instruct, all terminals in its cell accordingly. Further, the base station may configure a specific measurement configuration for an interference-related subframe measurement, and inform, i.e. instruct, all (or a specific subset of) terminals in its cell accordingly. Accordingly, a terminal in a specific cell may be configured to communicate using the same cell-specific UL-DL configuration, and to measure subframe interference of specific ones of the DL subframes in this UL-DL configuration based on the measurement configuration established by the base station of the respective cell in question. That is to say, each terminal may perform (e.g. CSI) measurements for one or more of a configured (sub-)set of DL subframes.

A measurement configuration according to exemplary embodiments of the present invention may define a set of all DL subframes of the frame structure or at least three subsets of the DL subframes of the frame structure (which may but need not be complementary). In this case, the at least three subsets of the DL subframes, which are defined by the measurement configuration, are derived as the measurement groups.

Accordingly, the terminal may be configured to perform interference measurements for 0 or M measurement groups, where M is equal to or larger than 3. Then, the terminal may report on the measurement result for the DL subframes in the 0 or M measurement groups. The 0 measurement group comprises all DL subframes in a specific UL-DL configuration, while the e.g. 3 measurement groups may for example comprise a subset of DL subframes 0 and 5, a subset of DL subframes 3 and 8, and a subset of DL subframes 4 and 9 (when assuming the TDD UL-DL configuration 2). Hence, the terminal may for example report a unified CQI for the entire set of DL subframes or separate CQIs for the configured three subframe subsets.

A measurement configuration according to exemplary embodiments of the present invention may define a set of all DL subframes of the frame structure or at least two subsets of the DL subframes of the frame structure (which may but need not be complementary). In this case, at least one of the set of all DL subframes and the at least two subsets of the DL subframes, which are defined by the measurement configuration, is divided so as to derive the measurement groups. That is to say, the at least three subsets of the DL subframes, which result from said dividing of the at least two subsets of the DL subframes of the measurement configuration, or the at least two subsets of the DL subframes, which result from said dividing of the set of all DL subframes of the measurement configuration, are derived as the measurement groups.

Accordingly, the terminal may be configured to perform interference measurements for 0 or M measurement groups, where M is equal to or larger than 2.

On the one hand, the terminal may be configured to perform interference measurements for the 0 measurement group or M measurement groups, where M is equal to or larger than 3, and the measurement groups result from dividing at least one of the at least two DL subframe subsets according to the measurement configuration. More specifically, when for example two subsets of DL subframes are configured for a terminal, the terminal may derive three measurement groups by dividing one of the two configured subsets or four measurement groups by dividing both of the two configured subsets. In this case, the 0 measurement group comprises all DL subframes in a specific UL-DL configuration, while the e.g. 3 measurement groups may for example comprise a subset of DL subframes 0 and 5, and two subset of DL subframes 3 and 8 as well as 4 and 9, which result from dividing the configured subset of DL subframes 3, 4, 8 and 9 (when assuming the TDD UL-DL configuration 2).

On the other hand, the terminal may be configured to perform interference measurements for two measurement groups, which result from dividing the set of all DL subframes according to the measurement configuration, and N measurement groups corresponding to N subsets of the DL subframes, where N is equal to or larger than 2. More specifically, when for example the entire set of DL subframes is configured for a terminal, the terminal may derive two measurement groups by dividing the configured entire set of DL subframes. In this case, the two measurement groups, which result from dividing the set of all DL subframes, may for example comprise a subset of DL subframes 0, 1, 5 and 6 and a subset of DL subframes 3, 4, 8 and 9, while the e.g. 2 measurement groups may for example comprise a subset of DL subframes 0, 1, 3 and 4 and a subset of DL subframes 5, 6, 8 and 9 (when assuming the TDD UL-DL configuration 2).

Further, the aforementioned variants may be combined in that both the set of all DL subframes and at least one of the subsets of the DL subframes are divided, respectively.

Still further, the aforementioned variants may be combined in that a measurement configuration defining a set of all DL subframes and two subsets of the DL subframes of may be used as a standard, while a measurement configuration defining a set of all DL subframes and three subsets of the DL subframes of may be used for a special set of terminals in the cell, e.g. for some cell edge UEs.

Then, the terminal may report on the measurement result for the DL subframes in at least one of measurement groups. Hence, the terminal may for example report a unified CQI for the entire set of DL subframes or separate CQIs for the configured and/or divided subsets of subframes.

In exemplary embodiments of the present invention, in which the terminal is enabled to further divide the subframes in one (sub-)set of the frame structure into groups according to the measurement configuration, such dividing or grouping may be made according to one of the predefined uplink-downlink configuration of the frame structure, a subframe index and a predefined division set comprising at least one of the downlink subframes. In this case, it may for example be controlled via higher layer or L1 (physical layer) signaling, how such dividing or grouping is to be made, i.e. which rule or rules are to be applied.

When denoting the CSI measurement (sub-)set to be further divided as S, the grouping of S can be done implicitly according to one or more of predefined rules.

According to a first exemplary rule, grouping may be based on the TDD UL-DL configuration.

For example, when TDD UL-DL configuration 2 is adopted, two complementary subsets of DL subframes may include {3,8,4,9} and {0,1,5,6}. When assuming S={3,8,4,9}, the resulting measurement groups may for example be S₀={3,8} and S₁={4,9}. Then, four measurement groups are {0,1,3,4,5,6,8}, {0,1,5,6}, {3,8} and {4,9}. When assuming the entire set of all DL subframes as the set to be divided, the resulting measurement groups may for example be S₀={0,1,5,6} and S₁={3,4,8,9}.

For example, when TDD UL-DL configuration 5 is adopted, two complementary subsets of DL subframes may include {0,1,5 . . . 9} and {3,4}. When assuming S={3,4}, the resulting measurement groups may for example be S₀={3} and S₁={4}. When assuming the entire set of all DL subframes as the set to be divided, the resulting measurement groups may for example be S₀={0,1,5 . . . 9} and S₁={3,4}.

According to a second exemplary rule, grouping may be based on a subframe index.

That is, the dividing may be such that two measurement groups result, for which holds: S₀={S(2i)} with i=0, 1, . . . , ceil(N/2)−1 and S₁={S(2i+1)} with i=0, 1, . . . , floor(N/2)−1, wherein N is the number of elements in the set S to be divided. For example, when TDD UL-DL configuration 2 is adopted and S={3,4,8,9} is assumed, the resulting measurement groups may for example be S₀={S(2i)} with i=0, 1, i.e. S₀={S(0),S(2)}={3,8} and S₁={S(2i+1)} with i=0, 1, i.e. S₀={S(1),S(3)}={4,9}.

According to a third exemplary rule, grouping may be based on a predefined division set.

That is, when the division set is denoted by A, the dividing may be such that two measurement groups result, for which holds: S₀=S∩A and S₁=S−(S∩A). For example, when TDD UL-DL configuration 2 is adopted and S={3,8,4,9} and A={3,8} are assumed, the resulting measurement groups may for example be S₀={3,8} and S₁={4,9}. For example, referring to the example of FIG. 2, the subframe being muted could be defined as the division set, i.e. A={4}.

It is noted that any combination of the aforementioned rules may also be applied, e.g. for different (sub-)sets of DL subframes to be divided (for example, when more measurement groups are desirable for achieving a sufficient resolution for measurement and reporting).

In view of the above, measures according to exemplary embodiments of the present invention are specifically directed to the fact that there can be UL-DL interference in flexible subframes. Accordingly, an eNB may for example configure the flexible subframe/s to be in a first CSI measurement group or subset and the fixed subframe/s to be in a second CSI measurement group or subset. Taking into account that an interference level in some flexible subframes can be less than in other flexible subframes, an eNB may for example configure three CSI measurement groups or subsets (in addition to the entire set of all DL subframes), e.g. with subset 0={3,8}, subset 1={4,9}, and subset 2={0,1,5,6}.

According to exemplary embodiments of the present invention, a terminal may be further configured to report a result of the interference measurement for the DL subframes of the at least one measurement group being measured to an access node or base station (e.g. the eNB) of the cellular communication system, e.g. in the form of a CQI report. That is, the reporting may be made for the smallest available group of DL subframes, which may result from a division as outlined above.

According to exemplary embodiments of the present invention, the reporting may be performed on the basis of an interference difference between subsequently measured measurement groups. That is, there may be a predefined threshold (which may for example be controlled by the eNB), the current measurement result of group X is only reported when the (absolute value of the) difference in interference between groups X and a previously measured (and reported) group X−1 is equal to or larger than a predefined threshold.

For example, only when a CQI difference between the CSI measurement subset i and a CSI measurement subset j which is previously reported within a time duration T is larger than the threshold, the terminal will effect the CQI report for CSI measurement subset i. That is, to reduce feedback overhead, a base station may define a threshold to help the terminals in its cell to decide whether or not to report a specific measurement result. For example, if |CQI_{—}1−CQI_{—}0|<Threshold and |CQI_{—}2−CQI_{—}1|>threshold, wherein CQI_{—}0 through CQI_{—}2 are measured in this temporal sequence, then a UE will only report CQI for subsets 0 and 2.

In case of a measurement group S_{0,1} resulting from division of a (sub-)set S of DL subframes, when the CQI difference between the CSI measurement groups S₀ and S₁ is smaller than the threshold, the terminal may effect the CQI report for the entire (sub-)set S, i.e. all DL subframes included in S₀ and S₁. Otherwise, when the CQI difference between the CSI measurement groups S₀ and S₁ is equal to or larger than the threshold, the terminal may effect separate CQI reports for S₀ and S₁.

When applying a threshold-related reporting approach as outlined above, each terminal may be enabled to stop sending the CQI report in case of a small difference in the CSI of two measurement groups, which may be determined at the UE side based on a threshold configured by the eNB. Such operation can save UE power and signaling overhead.

According to exemplary embodiments of the present invention, the reporting may be performed in a periodic manner based on a reporting period for the at least one measurement group (or the corresponding (sub-) set of DL subframes) or an aperiodic manner based on a reporting trigger for the at least one measurement group (or the corresponding (sub-) set of DL subframes). The relevant period or trigger may for example be controlled by the eNB.

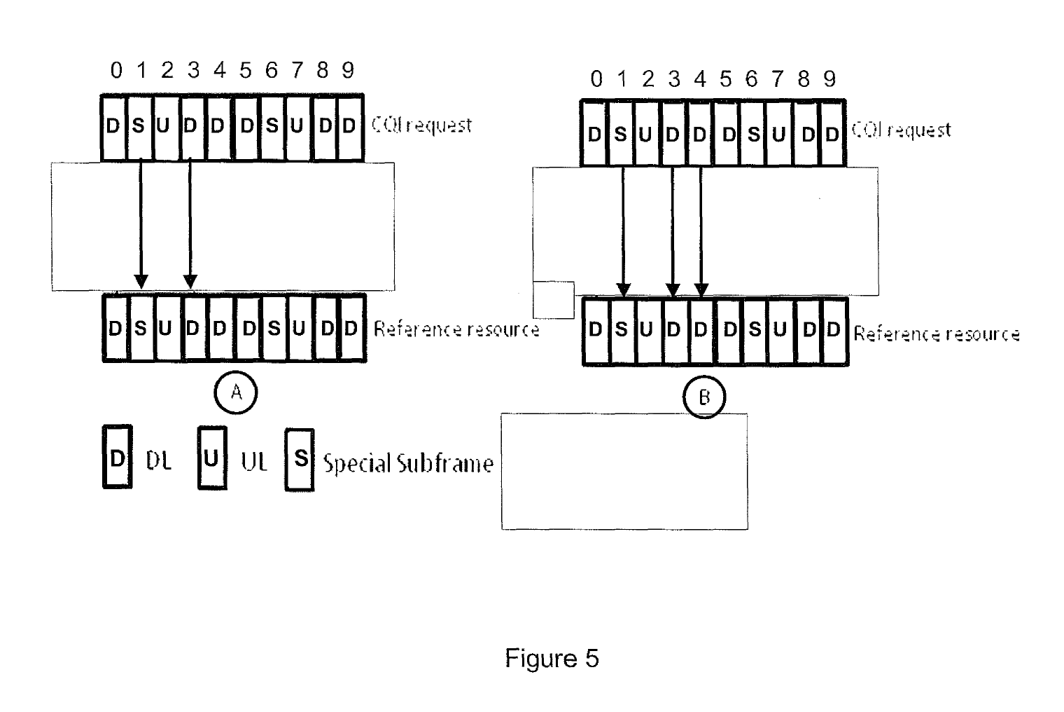

In case of a measurement group S_{0,1} resulting from division of a (sub-)set S of DL subframes, when periodic CQI reporting is configured for S, then CSI measurements and CQI reporting for small groups S₀ and S₁ may be periodically reported in a time divisional (TDM) manner, if more than one result is to be reported. If so, assuming a reporting period T, the CQI report for each group in a TDM manner will be effected in a period of 2T. When aperiodic, i.e. trigger-based, CQI reporting is configured for each divided group and is implicitly triggered by a CQI request or trigger, an implicit mapping may be defined between a subframe associated with the CQI request or trigger and a CQI reference subframe. Thereby, it may be verified for which group the CQI report should be sent. An example of such mapping is illustrated in FIG. 5.

FIG. 5 shows a schematic diagram of a mapping procedure according to exemplary embodiments of the present invention. The example of FIG. 5 is based on the TDD UL-DL configuration 2, as also adopted for cell#1 in the examples of FIGS. 1 and 2.

As shown in the left-hand side of FIG. 5, denoted by A, there is illustrated an implicit mapping of a CQI (or CSI) request subframe and a CQI (or CSI) reference resource in case of no grouping report being configured, i.e. when the measurement group for which the CQI (or CSI) report is to be issued is not a divided group. In this exemplary case, CQI request in DL subframe 1 is mapped to the measurement group of subframes {0,1,5,6}, and CQI request in DL subframe 3 is mapped to the measurement group of subframes {3,4,8,9}.

As shown in the right-hand side of FIG. 5, denoted by B, there is illustrated an implicit mapping of a CQI (or CSI) request subframe and a CQI (or CSI) reference resource in case of a grouping report being configured, i.e. when the measurement group for which the CQI (or CSI) report is to be issued is a divided group. In this exemplary case, CQI request in DL subframe 1 is mapped to the measurement group of subframes {0,1,5,6}, CQI request in DL subframe 3 is mapped to the measurement group of subframes {3,8}, and CQI request in DL subframe 4 is mapped to the measurement group of subframes {4,9}.

Accordingly, the mapped reference resource is in the same valid downlink subframe as the corresponding CQI (or CSI) request (in an uplink DCI format), and the difference between the cases of no grouping and grouping resides in that, with grouping, the terminal detects the CQI (or CSI) request to be mapped in more DL subframes (in the example of FIG. 5, in DL subframes 1, 3 and 4 Instead of in DL subframes 1 and 3).

According to exemplary embodiments of the present invention, the above-described measurement and reporting procedures may be utilized for/in various interference mitigation schemes and/or UL-DL re-configuration schemes. That is to say, the refined interference measurement and reporting according to exemplary embodiments of the present invention may be employed for addressing UL-DL interference in the application of TDD in cellular communication systems, especially when adopting different TDD UL-DL configurations in different (including neighboring) cells.

In this regard, according to exemplary embodiments of the present invention, the base station receiving a (e.g. CQI) report from a terminal may perform a reconfiguration procedure based on the received report of the result of the interference measurement, and may transmit a reconfiguration command resulting from the reconfiguration procedure to the terminal. Accordingly, the terminal receiving the reconfiguration command from the base station may adjust at least one of the setup of the predefined UL-DL configuration and the derivation measurement groups according to the reconfiguration command. Thereby, the terminal may reconfigure the TDD UL-DL configuration to be used for communication and/or the measurement group derivation based on the measurement configuration which may be changed by the base station, thus attaining different (possible more) measurement groups, and/or measures for reducing interference in the respective subframes may be taken on the basis of the information regarding existence and value of interference and the subframes for which the interference exists (or is highest), or the like.

According to exemplary embodiments of the present invention, the refined resolution of interference measurement and reporting may also be utilized for achieving an accurate link adaptation (e.g. for selection appropriate modulation codes for the data transmission between the base station and the terminal involved).

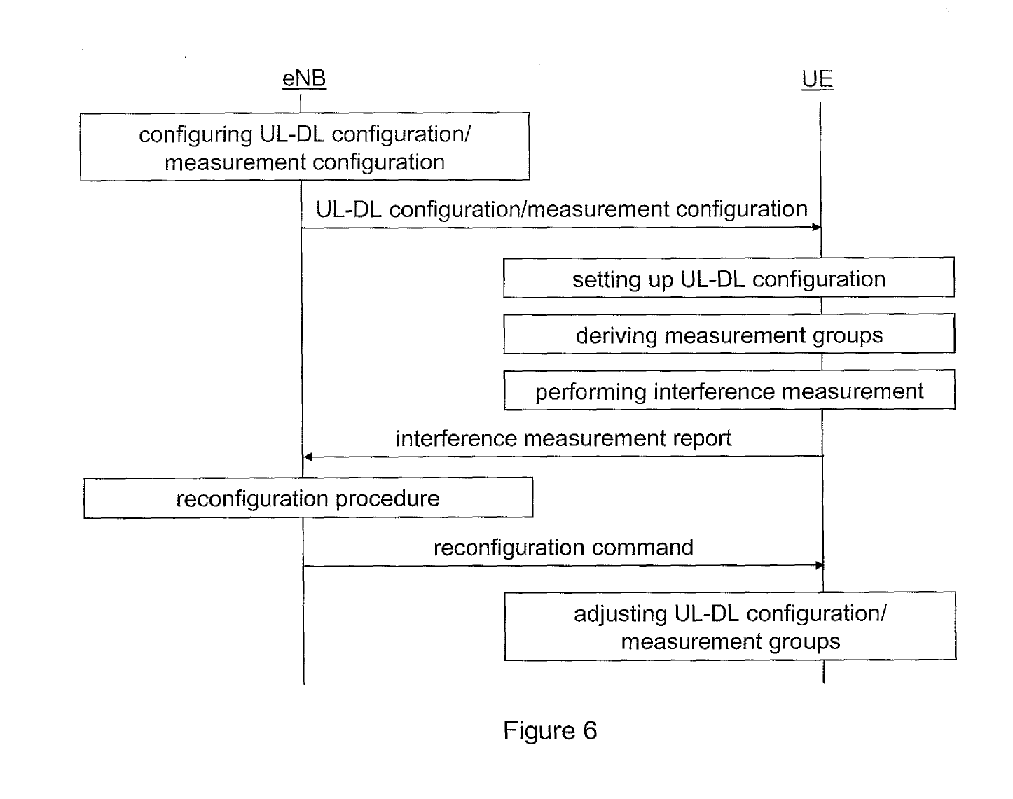

FIG. 6 shows a signaling diagram illustrating a procedure according to exemplary embodiments of the present invention. While FIG. 6 exemplarily illustrates a procedure involving most of the above-outlined aspects, it is to be noted that this illustration is only an example according to exemplary embodiments of the present invention, which is to depict an exemplary interaction between base station or access node eNB and terminal or user equipment UE.

According to exemplary embodiments of the present invention, the following effects may for example be achieved for various combinations of the above-outlined aspects of specific embodiment.

Exemplary embodiments may properly address situations in which UL-DL interference in some subframes can be less than in other subframes, and two CSI measurement subsets may not be enough to efficiently track the interference difference.

Exemplary embodiments may properly address situations in which a small number of terminals and/or low mobility characterize the traffic situation, such as in LA scenarios. As in such situations the frequency domain scheduling in a cell may not change fast, separate CQI report for different measurement groups, e.g. resulting from a division of larger subframe sets, are beneficial for link adaptation, UL-DL frame structure reconfiguration, or the like.

Exemplary embodiments may provide for large flexibility (e.g. in terms of eNB implementation) without significant change in signaling and implementation.

Exemplary embodiments may provide for advantages such as one or more of the following: an accurate link adaptation, UL-DL frame structure reconfiguration, or the like may be enabled; flexibility to report or not report based on interference status may be provided; reporting may be controllable by a base station or access node on the basis of reporting periods and/or triggers for periodic/aperiodic CQI triggers; and an implicit subframe grouping based subframe division may be tailored for flexible UL/DL configurations, and there may be no need to explicitly configure more than two subsets or measurement groups e.g. by a base station or access node.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

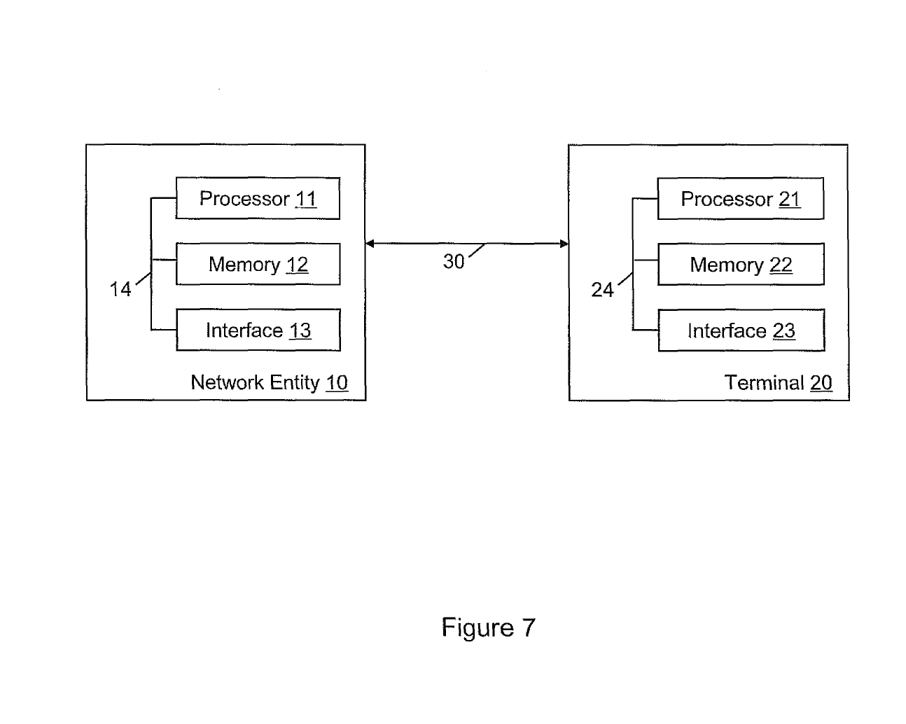

Respective exemplary embodiments of the present invention are described below referring to FIG. 7, while for the sake of brevity reference is made to the detailed description of respective corresponding methods and operations according to FIGS. 3 to 6.

In FIG. 7 below, which is noted to represent a simplified block diagram, the solid line blocks are basically configured to perform respective operations as described above. The entirety of solid line blocks are basically configured to perform the methods and operations as described above, respectively. With respect to FIG. 7, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-Independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 7, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 7 shows a block diagram illustrating exemplary apparatuses according to exemplary embodiments of the present invention.

In view of the above, the thus described apparatuses 10 and 20 are suitable for use in practicing the exemplary embodiments of the present invention, as described herein. The thus described apparatus 10 may represent a (part of a) network entity, i.e. base station or access node or controller, such as for example an eNB, a RNC, or the like, as described above, and may be configured to perform a procedure and/or exhibit a functionality as described in conjunction with any one of FIGS. 3, 5 and 6. The thus described apparatus 20 may represent a (part of a) device, terminal or user equipment UE, as described above, and may be configured to perform a procedure and/or exhibit a functionality as described in conjunction with any one of FIGS. 4 and 6.

As shown in FIG. 7, according to exemplary embodiments of the present invention, a network entity 10 comprises a processor 11, a memory 12, and an interface 13, which are connected by a bus 14 or the like, and a device, terminal or user equipment 20 comprises a processor 21, a memory 22, and an interface 23, which are connected by a bus 24 or the like. The device, terminal or user equipment 20 may be connected with the network entity 10 through a link or connection 30.

The memories 12 and 22 may store respective programs assumed to include program instructions that, when executed by the associated processors 11 and 21, enable the respective electronic device or apparatus to operate in accordance with the exemplary embodiments of the present invention. For example, the memory 12 of the network entity 10 may store the aforementioned database. The processors 11 and 21 and/or the interfaces 13 and 23 may also include a modem or the like to facilitate communication over the (hardwire or wireless) link 30, respectively. The interfaces 13 and 23 may include a suitable transceiver coupled to one or more antennas or communication means for (hardwire or wireless) communications with the linked or connected device(s), respectively. The interfaces 13 and 23 are generally configured to communicate with another apparatus, i.e. the interface thereof. For example, the interface 13 of the network entity 10 may communicate with another network entity (not shown) such as a controller (e.g. RNC) or some backhaul or core network entity which may be typically connected to an access node or base station in a cellular communication system.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

In the following, the functionality/operability of the individual apparatuses and means or parts thereof is described with reference to a specific configuration of the processor, the interface and the memory, respectively. Irrespective thereof, it is to be understood that corresponding functionality/operability may equally be realized with correspondingly adapted means independent of their implementation as processor, the interface and the memory, respectively. That is to say, the subsequently described processor, the interface and the memory represent respective means for accomplishing the corresponding functionality/operability for which the processor, the interface and the memory are described to be configured, respectively.

According to exemplary embodiments of the present invention, the interface 13 is configured for communication with at least another apparatus on the basis of a predefined UL-DL configuration of a frame structure for TDD communication. The processor 11 is configured to set up the predefined UL-DL configuration, said frame structure comprising a predefined number of DL subframes, to derive measurement groups from the frame structure according to a measurement configuration, said measurement configuration defining a set of all DL subframes of the frame structure or at least two subsets of the DL subframes of the frame structure, each of said measurement groups comprising a set of subframes out of the DL subframes of the frame structure, and to perform an interference measurement for the DL subframes of at least one of the measurement groups.

According to exemplary embodiments of the present invention, the processor 11 may be configured to receive, via the interface 13, a measurement configuration defining a set of all DL subframes of the frame structure or at least three subsets of the DL subframes of the frame structure, and the processor 11 may be configured to derive, as the measurement groups, the at least three subsets of the DL subframes, which are defined by the received measurement configuration.

According to exemplary embodiments of the present invention, the processor 11 may be configured to receive, via the Interface 13, a measurement configuration defining a set of all DL subframes of the frame structure or at least two subsets of the DL subframes of the frame structure, and the processor may be configured to divide at least one of the set of all DL subframes and the at least two subsets of the DL subframes, which are defined by the received measurement configuration, and to derive, as the measurement groups, the at least three subsets of the DL subframes, which result from said dividing of the at least two subsets of the DL subframes of the received measurement configuration, or the at least two subsets of the DL subframes, which result from said dividing of the set of all DL subframes of the received measurement configuration.

According to exemplary embodiments of the present invention, the processor 11 may be configured to group DL subframes in a respective set or subset into at least two groups according to one of the predefined UL-DL configuration of the frame structure, a subframe index and a predefined division set comprising at least one of the DL subframes.

According to exemplary embodiments of the present invention, the processor 11 may be configured to report, via the interface 13, a result of the interference measurement for the downlink subframes of the at least one measurement group to network entity 10. As outlined above, such reporting may be periodic or aperiodic, and may also be based on a threshold-related approach.

According to exemplary embodiments of the present invention, the processor 11 may be configured to receive, via the interface 13, a reconfiguration command from network entity 10, and the processor 11 may be configured to adjust at least one of the setup of the predefined UL-DL configuration and the derivation of the measurement groups according to the reconfiguration command.

According to exemplary embodiments of the present invention, the interface 23 is configured for communication with at least another apparatus on the basis of a predefined UL-DL configuration of a frame structure for TDD communication. The processor 21 is configured to configure the predefined UL-DL configuration of the frame structure for TDD communication, said frame structure comprising a predefined number of DL subframes, to configure a measurement configuration defining a set of all DL subframes of the frame structure or at least two subsets of the DL subframes of the frame structure, and to transmit, via the interface 23, the predefined UL-DL configuration and the measurement configuration to terminal 20.

According to exemplary embodiments of the present invention, the processor 21 may be configured to configure the measurement configuration to define a set of all DL subframes of the frame structure or at least three subsets of the DL subframes of the frame structure, or to define a set of all DL subframes of the frame structure or at least two subsets of the DL subframes of the frame structure.

According to exemplary embodiments of the present invention, the processor 21 may be configured to receive, from terminal 10 via the interface 23, a report of a result of an interference measurement for the downlink subframes of at least one measurement group. The report may be received in one of a periodic manner based on a reporting period for the at least one measurement group and an aperiodic manner based on a reporting trigger for the at least one measurement group, wherein the processor 21 may be configured to set the reporting period and/or the reporting trigger.

According to exemplary embodiments of the present invention, the processor 21 may be configured to perform a reconfiguration procedure based on a received report of the result of the interference measurement, and to transmit, via the interface 23, a reconfiguration command resulting from the reconfiguration procedure to terminal 10.

According to exemplarily embodiments of the present invention, the processor 11 or 21, the memory 12 or 22 and the interface 13 or 23 can be implemented as individual modules, chipsets or the like, or one or more of them can be implemented as a common module, chipset or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or exemplary embodiments thereof provide measures for interference control in time division duplex communication. Such measures may exemplarily comprise setting up a predefined uplink-downlink configuration of a frame structure for time division duplex communication, said frame structure comprising a predefined number of downlink subframes, deriving measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and performing an interference measurement for the downlink subframes of at least one of the measurement groups.

Stated in other words, referring to exemplary embodiments of the present invention, there are provided measurement and reporting procedures e.g. for CSI measurements and CQI reports in TDD systems, e.g. LA TDD systems, with flexible, i.e. cell-specific, TDD UL-DL configurations. By virtue of such procedures, a base station may be made aware of all information required for taking appropriate measures such as interference mitigation schemes and/or UL-DL re-configuration schemes, including link adaptation or the like. Namely, a base station may obtain information of the existence of interference in a TDD frame structure, the amount of interference (e.g. the SINR difference in respective subframes), and the subframes in which the interference exists. Namely, information of a sufficient resolution are made available, which are effective for solving above-explained problems in terms of interference in neighboring cells due to flexible frame structures, e.g. for adapting UL-DL interference in LA TDD systems with cell-specific TDD UL-DL configurations.

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

AP Access Point (LAN base station)
CQI Channel Quality Indication
CSI Channel State Information
DCI Downlink Control Information
DL Downlink
eNB evolved Node B (E-UTRAN base station)
E-UTRAN Evolved Universal Terrestrial Radio Access Network
HARQ Hybrid Automatic Repeat Request
LAN Local Area Network
LTE Long Term Evolution
LTE-A Long Term Evolution Advanced
RNC Radio Network Controller
SINR Signal-to-Interference-plus-Noise Ratio
TDD Time Division Duplex
TDM Time Division Multiplex
UE User Equipment
UL Uplink

What is claimed is:

1. A method comprising:
setting up a predefined uplink-downlink configuration of a frame structure for time division duplex communication, said frame structure comprising a predefined number of downlink subframes,
deriving measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and
performing an interference measurement for the downlink subframes of at least one of the measurement groups.

2. The method according to claim 1, further comprising:
receiving a measurement configuration defining a set of all downlink subframes of the frame structure or at least three subsets of the downlink subframes of the frame structure,
wherein the at least three subsets of the downlink subframes, which are defined by the received measurement configuration, are derived as the measurement groups.

3. The method according to claim 1, further comprising
receiving a measurement configuration defining a set of all downlink subframes of the frame structure or at least two subsets of the downlink subframes of the frame structure,
said deriving comprising dividing at least one of the set of all downlink subframes and the at least two subsets of the downlink subframes, which are defined by the received measurement configuration,
wherein the at least three subsets of the downlink subframes, which result from said dividing of the at least two subsets of the downlink subframes of the received measurement configuration, or the at least two subsets of the downlink subframes, which result from said dividing of the set of all downlink subframes of the received measurement configuration, are derived as the measurement groups.

4. The method according to claim 3, wherein
said dividing comprises grouping of downlink subframes in the respective set or subset into at least two groups according to one of the predefined uplink-downlink configuration of the frame structure, a subframe index and a predefined division set comprising at least one of the downlink subframes.

5. The method according to claim 1, further comprising
reporting a result of the interference measurement for the downlink subframes of the at least one measurement group to an access node or base station of a cellular communication system, said reporting being performed in one of a periodic manner based on a reporting period for the at least one measurement group and an aperiodic manner based on a reporting trigger for the at least one measurement group.

6. The method according to claim 5 wherein
in case of a periodic reporting, the reporting for the at least one measurement group is made in a time division manner in a predefined reporting period of the set of all downlink subframes or the at least two subsets of the downlink subframes, which are defined by the received measurement configuration, and from a division of which the at least one measurement group results, while
in case of an aperiodic reporting, the reporting trigger for the at least one measurement group is a reporting trigger in a subframe of the set of all downlink subframes or the at least two subsets of the downlink subframes, which is mapped to a subframe of a reference set of the downlink frames, and/or
said reporting is performed for the set of all downlink subframes or the at least two subsets of the downlink subframes, which are defined by the received measurement configuration, and from a division of which the at least one measurement group results, when an absolute value of a difference between the recently measured interference of a measurement group in question and the previously measured interference of another measurement group, which has been reported within an elapsed time which is shorter than a predefined time duration, is equal to or smaller than a predefined threshold.

7. The method according to claim 5, wherein
said reporting is performed for the at least one measurement group when an absolute value of a difference between the recently measured interference of a measurement group in question and the previously measured interference of another measurement group, which has been reported within an elapsed time which is shorter than a predefined time duration, is larger than a predefined threshold, and/or
said reporting is performed in the form of a channel quality indication report.

8. The method according to claim 1, further comprising
receiving a reconfiguration command from an access node or base station of a cellular communication system, and
adjusting at least one of the setup of the predefined uplink-downlink configuration and the derivation of the measurement groups according to the reconfiguration command.

9. The method according claim 1, wherein
the method is operable at or by a terminal or user equipment of a cellular communication system, and/or
the interference measurement is performed in the form of channel state information.

10-15. (canceled)

16. An apparatus comprising
an interface configured for communication with at least another apparatus on the basis of a predefined uplink-downlink configuration of a frame structure for time division duplex communication, and
a processor configured to
set up the predefined uplink-downlink configuration of the frame structure for time division duplex communication, said frame structure comprising a predefined number of downlink subframes,
derive measurement groups from the frame structure according to a measurement configuration, said measurement configuration defining a set of all downlink subframes of the frame structure or at least two subsets of the downlink subframes of the frame structure, each of said measurement groups comprising a set of subframes out of the downlink subframes of the frame structure, and
perform an interference measurement for the downlink subframes of at least one of the measurement groups.

17. The apparatus according to claim 16, wherein
the processor, via the interface, is configured to receive a measurement configuration defining a set of all downlink subframes of the frame structure or at least three subsets of the downlink subframes of the frame structure, and
the processor is configured to derive, as the measurement groups, the at least three subsets of the downlink subframes, which are defined by the received measurement configuration.

18. The apparatus according to claim 16, wherein
the processor, via the interface, is configured to receive a measurement configuration defining a set of all downlink subframes of the frame structure or at least two subsets of the downlink subframes of the frame structure, and
the processor is configured to divide at least one of the set of all downlink subframes and the at least two subsets of the downlink subframes, which are defined by the received measurement configuration, and to derive, as the measurement groups, the at least three subsets of the downlink subframes, which result from said dividing of the at least two subsets of the downlink subframes of the received measurement configuration, or the at least two subsets of the downlink subframes, which result from said dividing of the set of all downlink subframes of the received measurement configuration.

19. The apparatus according to claim 18, wherein
the processor, for dividing, is configured to group downlink subframes in the respective set or subset into at least two groups according to one of the predefined uplink-downlink configuration of the frame structure, a subframe index and a predefined division set comprising at least one of the downlink subframes.

20-24. (canceled)

25. An apparatus comprising
an interface configured for communication with at least another apparatus on the basis of a predefined uplink-downlink configuration of a frame structure for time division duplex communication, and
a processor configured to
configure the predefined uplink-downlink configuration of the frame structure for time division duplex communication, said frame structure comprising a predefined number of downlink subframes,
configure a measurement configuration defining a set of all downlink subframes of the frame structure or at least two subsets of the downlink subframes of the frame structure, and
transmit, via the interface, the predefined uplink-downlink configuration and the measurement configuration to a terminal or user equipment of a cellular communication system.

26. The apparatus according to claim 25, wherein
the processor is configured to configure the measurement configuration to define a set of all downlink subframes of the frame structure or at least three subsets of the downlink subframes of the frame structure, or to define a set of all downlink subframes of the frame structure or at least two subsets of the downlink subframes of the frame structure.

27. The apparatus according to claim 25, wherein
the processor is configured to receive, from the terminal or user equipment via the interface, a report of a result of an interference measurement for the downlink subframes of at least one measurement group, said report being received in one of a periodic manner based on a reporting period for the at least one measurement group and an aperiodic manner based on a reporting trigger for the at least one measurement group.

28. The apparatus according to claim 27, wherein
the at least one measurement group, of which the report is received, is at least one of the at least three subsets of the downlink subframes, which are defined by the measurement configuration, or the at least three subsets of the downlink subframes, which result from dividing of the at least two subsets of the downlink subframes of the measurement configuration, or the at least two subsets of the downlink subframes, which result from dividing of the set of all downlink subframes of the measurement configuration, and/or
said report is in the form of a channel quality indication report.

29. The apparatus according to claim 27, wherein
the processor is configured to perform a reconfiguration procedure based on the received report of the result of the interference measurement, and
the processor is configured to transmit, via the interface, a reconfiguration command resulting from the reconfiguration procedure to the terminal or user equipment.

30-32. (canceled)
